(19) United States
(12) Patent Application Publication
(10) Pub. No.: US 2021/0381831 A1
(43) Pub. Date: Dec. 9, 2021

(54) SENSOR AND ELECTRONIC DEVICE

(71) Applicant: KABUSHIKI KAISHA TOSHIBA, Tokyo (JP)

(72) Inventors: Ryunosuke GANDO, Yokohama Kanagawa (JP); Yasushi TOMIZAWA, Fuchu Tokyo (JP); Daiki ONO, Yokohama Kanagawa (JP); Kei MASUNISHI, Kawasaki Kanagawa (JP)

(73) Assignee: KABUSHIKI KAISHA TOSHIBA, Tokyo (JP)

(21) Appl. No.: 17/162,001

(22) Filed: Jan. 29, 2021

(30) Foreign Application Priority Data
Jun. 5, 2020 (JP) 2020-098552

(51) Int. Cl. G01C 19/5712; G01C 19/5726; G01C 19/5755

(52) U.S. Cl. CPC G01C 19/5712; G01C 19/5755; G01C 19/5726

(57) ABSTRACT

According to one embodiment, a sensor includes a processor. The processor is configured to acquire a first angle value from an angle gyro sensor and acquire a first angular velocity value from an angular velocity gyro sensor, and perform at least first processing. The first processing includes outputting a second angular velocity value by correcting the first angular velocity value by using a value obtained by filtering a difference between the first angle value and a post-processing angle value. The post-processing angle value is obtained by processing the first angular velocity value.

### CROSS-REFERENCE TO RELATED APPLICATIONS

This application is based upon and claims the benefit of priority from Japanese Patent Application No. 2020-098552, filed on Jun. 5, 2020; the entire contents of which are incorporated herein by reference.

### FIELD

Embodiments of the invention generally relate to a sensor and an electronic device.

### BACKGROUND

There is a sensor such as a gyro sensor or the like. It is desirable to increase the detection accuracy of the sensor and an electronic device.

### BRIEF DESCRIPTION OF THE DRAWINGS

FIG. 1 is a schematic view illustrating a sensor according to a first embodiment;

FIG. 2 is a schematic view illustrating an operation of a sensor;

FIG. 3 is a schematic view illustrating an operation of a sensor;

FIGS. 4A and 4B are schematic views illustrating the outputs of sensors;

FIG. 5 is a schematic view illustrating a sensor according to the first embodiment;

FIG. 6 is a schematic view illustrating a sensor according to a second embodiment;

FIG. 7 is a schematic plan view illustrating a portion of the sensor according to the embodiment;

FIG. 8 is a schematic plan view illustrating a portion of the sensor according to the embodiment;

FIGS. 9A and 9B are schematic views illustrating a portion of the sensor according to the embodiment;

FIG. 10 is a schematic view illustrating the electronic device according to the third embodiment; and

FIGS. 11A to 11H are schematic views illustrating applications of the electronic device.

### DETAILED DESCRIPTION

According to one embodiment, a sensor includes a processor. The processor is configured to acquire a first angle value from an angle gyro sensor and acquire a first angular velocity value from an angular velocity gyro sensor, and perform at least first processing. The first processing includes outputting a second angular velocity value by correcting the first angular velocity value by using a value obtained by filtering a difference between the first angle value and a post-processing angle value. The post-processing angle value is obtained by processing the first angular velocity value.

According to one embodiment, a sensor includes a processor. The processor is configured to acquire a first angle value from an angle gyro sensor and acquire a first acceleration value from an acceleration sensor, and second processing. The second processing includes deriving a second acceleration value by correcting the first acceleration value based on a correction value based on the first angle value and a gravitational force.

According to one embodiment, an electronic device includes any one of the sensors described above, and a circuit controller configured to control a circuit based on a signal obtained from the sensor.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

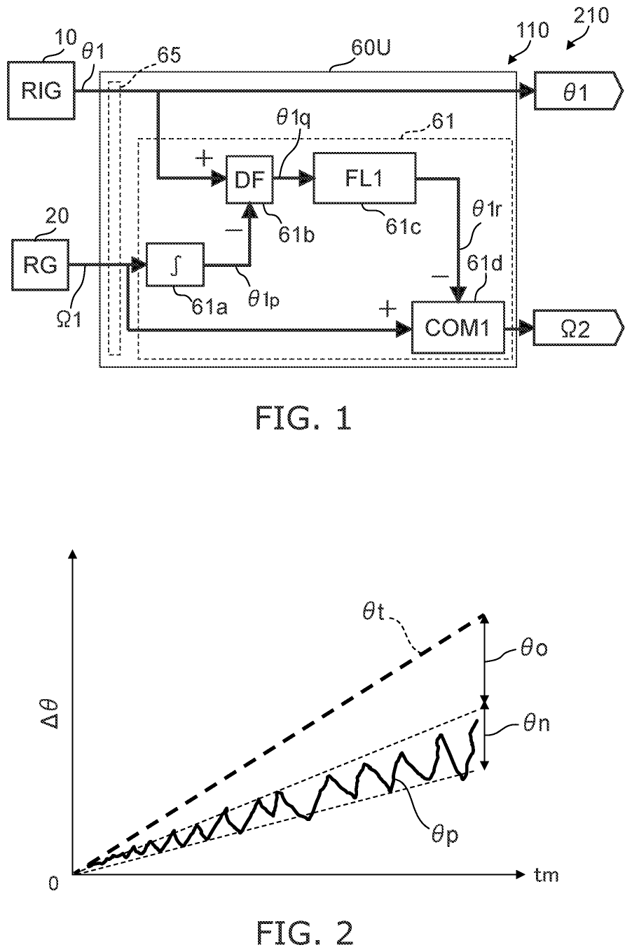

FIG. 1 is a schematic view illustrating a sensor according to a first embodiment.

As shown in FIG. 1, the sensor 110 according to the first embodiment includes a processor 60U. The processor 60U acquires a first angle value θ1 and a first angular velocity value Ω1 and performs first processing, which is described below.

For example, the processor 60U is an electronic circuit (including a computer, etc.). For example, an acquisition part 65, a first processor 61, etc., are provided in the processor 60U. The acquisition part 65 is configured to acquire the first angle value θ1 and the first angular velocity value Ω1. The acquisition part 65 may be, for example, an input port (an input/output port). The first processor 61 is a functional block that performs the first processing. The processor 60U is configured to output a signal corresponding to the result of the first processing. For example, the signal may be output externally from the acquisition part 65 (e.g., the input/output port).

The first angle value θ1 is obtained from an angle gyro sensor 10. The angle gyro sensor 10 is, for example, a RIG (Rate Integrating Gyroscope). For example, the angle gyro sensor 10 is configured to directly measure an angle of a detection object. For example, the angle gyro sensor 10 can measure the angle of the detection object without an integration operation. Thus, the first angle value θ1 is obtained by the angle gyro sensor 10 directly measuring the angle of the detection object.

The first angular velocity value Ω1 is obtained from an angular velocity gyro sensor 20. The angular velocity gyro sensor 20 is, for example, a RG (Rate Gyroscope). For example, the angular velocity gyro sensor 20 is configured to detect a value that includes the angular velocity of the detection object. In addition to the angular velocity of the detection object (e.g., the true angular velocity), the first angular velocity value Ω1 that is obtained from the angular velocity gyro sensor 20 may include offset due to effects of a circuit or the like, random noise due to the effects of a circuit or the like, etc.

The angle gyro sensor 10 may be provided separately from the sensor 110. The angle gyro sensor 10 may be included in a sensor 210. The angular velocity gyro sensor 20 may be provided separately from the sensor 110. The angular velocity gyro sensor 20 may be included in the sensor 210. The sensor 210 includes the sensor 110 and at least one of the angle gyro sensor 10 or the angular velocity gyro sensor 20. The sensor 210 is, for example, an IMU (Inertial Measurement Unit). As described below, the sensor 210 may include an acceleration sensor.

The first processing is performed by a calculator included in the processor 60U. When the first processing is performed by a calculator, at least a portion of the calculator corresponds to the first processor 61 (referring to FIG. 1). In the description hereinbelow, the first processing is performed by the first processor 61.

The first processing includes outputting a second angular velocity value Ω2. In other words, the first processor 61 is configured to output the second angular velocity value Ω2. The second angular velocity value Ω2 is a value generated by correcting the first angular velocity value Ω1.

As shown in FIG. 1, for example, the first processor 61 derives a difference Ω1q between the first angle value θ1 and a post-processing angle value θ1p that is obtained by processing the first angular velocity value Ω1. The first processor 61 outputs the second angular velocity value Ω2 by correcting the first angular velocity value Ω1 by using a value θ1r obtained by filtering the difference θ1q. For example, the post-processing angle value θ1p is obtained by integrating the first angular velocity value Ω1.

For example, an integration processor 61a, a difference processor 61b (a complementary error calculator DF), a first filter processor 61c (a complementary filter FL1), and a correction processor 61d (a corrector COM1) are provided in the first processor 61. These processors are functional blocks that are provided in the first processor 61 (the processor 60U).

For example, the integration processor 61a derives the post-processing angle value θ1p by integrating the first angular velocity value Ω1. The post-processing angle value θ1p and the first angle value θ1 are input to the difference processor 61b. The difference processor 61b derives the difference θ1q as the angle of the difference between the post-processing angle value θ1p and the first angle value θ1. The difference θ1q that is derived is input to the first filter processor 61c. The first filter processor 61c filters the difference θ1q.

The filtering that is performed by the first filter processor 61c includes, for example, Kalman filtering (including complimentary Kalman filtering) of the difference θ1q. In complimentary Kalman filtering, it is possible to estimate the states of multiple sensor errors as a dynamic system by using, as an observed value, a sensor error obtained from the difference between outputs of the multiple sensors (e.g., the angle gyro sensor 10 and the angular velocity gyro sensor 20) that have mutually-different error characteristics.

In Kalman filtering, for example, the current state estimated value and the state predicted value of one-step subsequent are derivable from a current observed quantity of the object system and the state estimated value of one-step previous. In Kalman filtering, for example, a prediction and an update are performed each time step. In the prediction, for example, the estimated state of the current time is calculated from the estimated state of the previous time. In the update, a more accurate state is estimated by correcting the estimated value by using the observed value of the current time.

Other than the angular velocity of the detection object, for example, components (e.g., the offset, random noise, etc.) that are included in the first angular velocity value Ω1 can be derived by performing Kalman filtering of the difference θ1q. The filtering that is performed by the first filter processor 61c may include processing based on a first-principle model.

The first angular velocity value Ω1 and the value θ1r that is obtained by filtering the difference θ1q are input to the correction processor 61d. The correction processor 61d outputs the second angular velocity value Ω2 by correcting the first angular velocity value Ω1 by using the value θ1r and the first angular velocity value Ω1.

The other components (e.g., the offset, random noise, etc.) that are included in the first angular velocity value Ω1 are removed from the second angular velocity value Ω2. The second angular velocity value Ω2 is accurate. According to the embodiment, a sensor can be provided in which the accuracy can be increased.

According to the sensor 110 (or the sensor 210), an integral error is not generated in the first angle value θ1 obtained from the angle gyro sensor 10. For example, a high-bandwidth angle detection result is obtained with high accuracy and good temperature characteristics. Also, the offset is removed from the second angular velocity value Ω2 obtained by processing that uses the angle gyro sensor 10 and the angular velocity gyro sensor 20. An angular velocity detection result is obtained with high accuracy and good temperature characteristics. According to the embodiment, the angular velocity is obtained with high accuracy by combining and correcting RIG and RG.

An example of the first angular velocity value Ω1 obtained from the angular velocity gyro sensor 20 will now be described.

FIG. 2 is a schematic view illustrating an operation of a sensor.

FIG. 2 corresponds to a reference example in which the angle is derived by integrating the angular velocity (the first angular velocity value Ω1) obtained from the angular velocity gyro sensor 20. The horizontal axis of FIG. 2 is a time tm. The vertical axis is an angle change Δθ. FIG. 2 schematically shows a “true angle”θt and an angle θp (an operation output) obtained by integrating the first angular velocity value Ω1. In the example of FIG. 2, the angle change Δθ is taken to be 0 when the time tm is 0.

As shown in FIG. 2, the true angle θt and the angle θp increase as the time tm elapses. As described above, in addition to the angular velocity (e.g., the “true angular velocity”) of the detection object, the first angular velocity value Ω1 that is obtained from the angular velocity gyro sensor 20 includes the offset due to effects of a circuit or the like, random noise due to the effects of a circuit or the like, etc. Therefore, as shown in FIG. 2, there are cases where the angle θp that is obtained by integrating the first angular velocity value Ω1 does not match the true angle θt. As shown in FIG. 2, the angle θp is affected by a component (an offset θo) based on the circuit bias and by a component (random noise θn) based on the circuit noise. Not only the angle (the true angle θt) based on the true angular velocity but also the offset θo and the random noise θn increase over time. Therefore, in the reference example, there are cases where the angle that is obtained by integrating the angular velocity includes a large error.

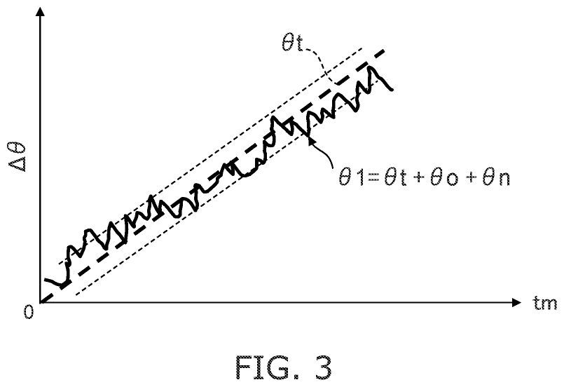

FIG. 3 is a schematic view illustrating an operation of a sensor.

FIG. 3 illustrates the angle (the first angle value θ1) obtained from the angle gyro sensor 10. The horizontal axis of FIG. 3 is the time tm. The vertical axis is the angle change Δθ. FIG. 3 schematically shows the first angle value θ1 and the true angle θt. In the example of FIG. 3, the angle change Δθ is taken to be 0 when the time tm is 0.

As shown in FIG. 3, the first angle value θ1 includes the true angle θt, the component (the offset θo) based on the circuit bias, and the component (the random noise θn) based on the circuit noise. Unlike the reference example described above, the offset θo and the random noise θn do not increase with respect to the time tm. The temporal summation of the offset θo and the random noise θn that occurs in the reference example described above can be avoided in the angle (the first angle value θ1) obtained from the angle gyro sensor 10.

Accordingly, the temporal summation components of the offset θo and the random noise en can be derived by deriving the difference θ1q between the first angle value θ1 and the post-processing angle value θ1p obtained by processing (integrating) the first angular velocity value Ω1. Then, the second angular velocity value Ω2 is obtained with a high accuracy by correcting the first angular velocity value Ω1 by using the value θ1r obtained by filtering the difference θ1q.

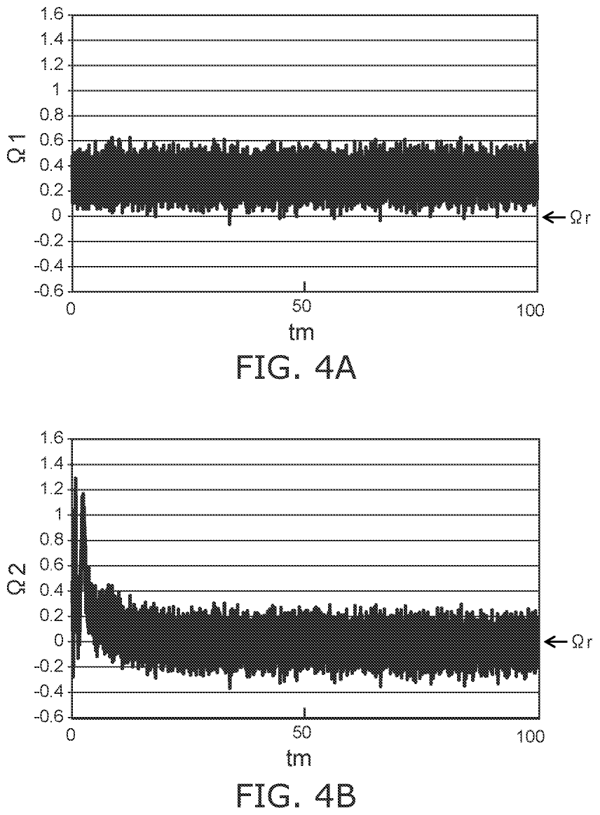

FIGS. 4A and 4B are schematic views illustrating the outputs of sensors.

In these figures, the horizontal axis is the time tm. The vertical axis of FIG. 4A is the first angular velocity value Ω1 obtained from the angular velocity gyro sensor 20. The vertical axis of FIG. 4B is the second angular velocity value Ω2 in which the first angular velocity value Ω1 is corrected by the method described above. These figures show a “true angular velocity Ωr”. As shown in FIG. 4A, the first angular velocity value Ω1 has an offset with respect to the “true angular velocity Ωr”. On the other hand, as shown in FIG. 4B, the second angular velocity value Ω2 has the value of the “true angular velocity Ωr” because the offset is removed because the second angular velocity value Ω2 reflects the corrections as the time tm elapses.

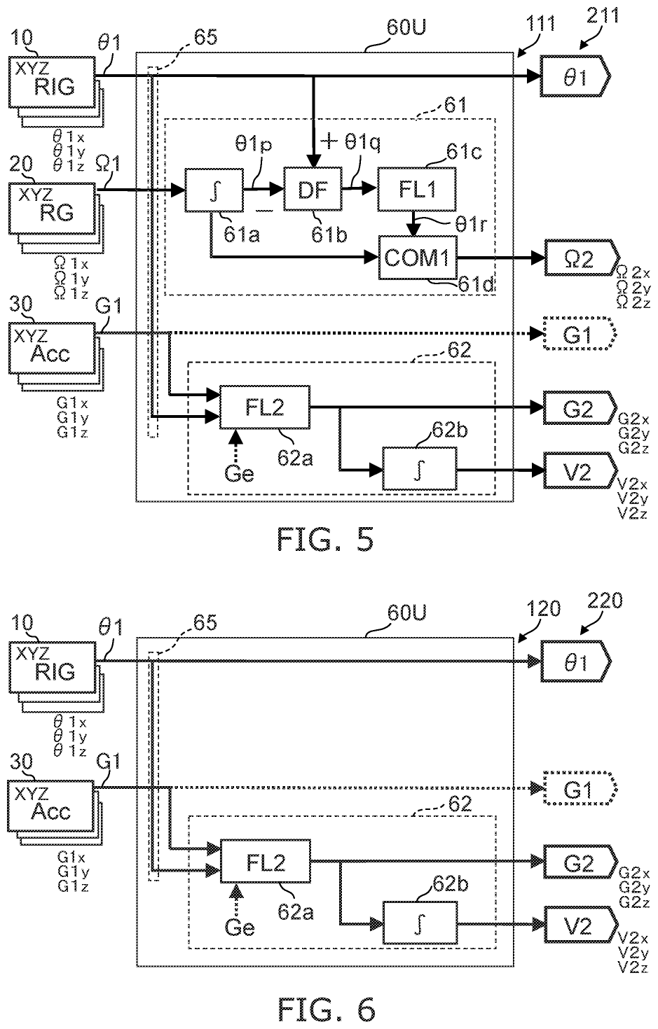

FIG. 5 is a schematic view illustrating a sensor according to the first embodiment.

As shown in FIG. 5, the sensor 111 according to the first embodiment also includes the processor 60U. In the sensor 111, the processor 60U acquires the first angle value θ1 and the first angular velocity value Ω1 and performs the first processing described above. The first angle value θ1 and the first angular velocity value Ω1 may include values along three mutually-orthogonal axes. The first processing for the angle and angular velocity may be performed for a three-dimensional system.

For example, the first angle value θ1 includes an X-axis angle value θ1x relating to the X-axis, a Y-axis angle value θ1y relating to the Y-axis, and a Z-axis angle value θ1z relating to the Z-axis. The first angular velocity value Ω1 includes an X-axis angular velocity value Ω1x relating to the X-axis, a Y-axis angular velocity value Ω1y relating to the Y-axis, and a Z-axis angular velocity value Ω1z relating to the Z-axis. The X-axis, the Y-axis, and the Z-axis are orthogonal to each other.

For example, the X-axis angular velocity value Ω1x, the Y-axis angular velocity value Ω1y, and the Z-axis angular velocity value Ω1z each are corrected. For example, the second angular velocity value Ω2 includes an X-axis angular velocity value Ω2x relating to the X-axis, a Y-axis angular velocity value Ω2y relating to the Y-axis, and a Z-axis angular velocity value Ω2z relating to the Z-axis.

In the sensor 111 as shown in FIG. 5, the processor 60U is configured to further acquire a first acceleration value G1 and to further perform second processing, which is described below.

The first acceleration value G1 is obtained from an acceleration sensor 30. The acceleration sensor 30 is, for example, an acceleration sensor Acc (Accelerometer) relating to a translation. The acceleration sensor 30 may be provided separately from the sensor 110. The acceleration sensor 30 may be included in the sensor 211 (e.g., the IMU).

The first acceleration value G1 may include an X-axis acceleration value G1x relating to the X-axis, a Y-axis acceleration value G1y relating to the Y-axis, and a Z-axis acceleration value G1z relating to the Z-axis.

The second processing is performed by a calculator included in the processor 60U. When the second processing is performed by the calculator, at least a portion of the calculator corresponds to a second processor 62 (referring to FIG. 5). In the description hereinbelow, the second processing is performed by the second processor 62.

The second processing includes deriving a second acceleration value G2 by correcting the first acceleration value G1. The second acceleration value G2 may be output. The processor 60U is configured to output the result (the velocity) obtained by processing (e.g., integrating) the result (the second acceleration value G2) of the second processing. For example, the result (e.g., the signal) may be output externally from the acquisition part 65 (e.g., the input/output port).

For example, the second acceleration value G2 that relates to the three axes is obtained by correcting the first acceleration value G1 that relates to the three axes. For example, the second acceleration value G2 includes an X-axis acceleration value G1x relating to the X-axis, a Y-axis acceleration value G1y relating to the Y-axis, and a Z-axis acceleration value G2z relating to the Z-axis.

In the second processing, the second acceleration value G2 is obtained by correcting the first acceleration value G1 based on a correction value based on the first angle value θ1 and the gravitational force.

For example, the processor 60U includes the second processor 62. The second processing is performed by the second processor 62. The second processor 62 corresponds to at least a portion of the calculator included in the processor 60U. The operations that are performed by the second processor 62 may be performed by at least a portion of the first processor 61.

For example, a second filter processor 62a (an acceleration separation filter FL2) and an integration processor 62b are provided in the second processor 62. These processors are functional blocks provided in the second processor 62 (the processor 60U).

For example, the first angle value θ1 and the first acceleration value G1 are input to the second filter processor 62a. The correction value that is based on the first angle value θ1 and a gravitational force Ge is derived by the second filter processor 62a. The correction value is based on the product of the gravitational force Ge and the sine of the first angle value θ1.

For example, the value that is detected by the acceleration sensor 30 includes a gravitational force component in addition to the acceleration (the “true acceleration Gr”) of the detection object. In other words, the first acceleration value G1 is represented by sin(θ1)×Ge+Gr. For example, the second acceleration value G2 is obtained by correcting the first acceleration value G1 by using “sin(θ1)×Ge” as the correction value. The effects of the gravitational force that occur according to the rotation are removed from the second acceleration value G2. The second acceleration value G2 has high accuracy. According to the embodiment, a sensor is provided in which the accuracy can be increased.

As described above, the second processing includes separating the acceleration of the linear motion and the gravitational force change based on the rotation.

The second processing may include outputting a velocity value V2 by integrating the second acceleration value G2. For example, the second acceleration value G2 after the correction is input to the integration processor 62b. The integration processor 62b outputs the velocity value V2 obtained by integrating the second acceleration value G2.

This processing may be performed for the three axes. For example, the velocity value V2 may include an X-axis velocity value V2x relating to the X-axis, a Y-axis velocity value V2y relating to the Y-axis, and a Z-axis velocity value V2z relating to the Z-axis.

In the sensor 111 (or the sensor 211), the velocity value V2 is obtained with high accuracy in addition to the angle detection result having high accuracy (good temperature characteristics and a high bandwidth) and the angular velocity detection result having high accuracy (offset suppression and good temperature characteristics). The integral error of the velocity value V2 is suppressed, and the effects of the gravitational force and the rotation are suppressed. According to the embodiment, by combining a RIG and an Acc, the acceleration of the linear motion and the acceleration due to the gravitational force can be separated, and the velocity is obtained with high accuracy.

### Second Embodiment

FIG. 6 is a schematic view illustrating a sensor according to a second embodiment.

As shown in FIG. 6, the sensor 120 according to the second embodiment includes the processor 60U. The processor 60U acquires the first angle value θ1 and the first acceleration value G1 and performs the second processing. The first angle value θ1 is obtained from the angle gyro sensor 10 (the RIG). The first acceleration value G1 is obtained from the acceleration sensor 30 (the Acc). The second processing of the sensor 120 may be similar to the second processing described with reference to the sensor 111 (the sensor 211). For example, the second processor 62 may be provided in the processor 60U. The second filter processor 62a (the acceleration separation filter FL2) and the integration processor 62b are provided in the second processor 62. These processors may perform processing similar to the processing described with reference to the sensor 111 (the sensor 211).

For example, the second processing includes deriving the second acceleration value G2 by correcting the first acceleration value G1 based on a correction value based on the first angle value θ1 and the gravitational force Ge. The second processing may include outputting the second acceleration value G2. The correction value is based on the product of the gravitational force Ge and the sine of the first angle value θ1 (sin(θ1)×Ge). The second processing includes, for example, separating the acceleration of the linear motion and the gravitational force change based on the rotation. The second processing may include outputting the velocity value V2 generated by integrating the second acceleration value G2.

In the sensor 120 (or a sensor 220), the velocity value V2 is obtained with high accuracy in addition to the angle detection result having high accuracy (good temperature characteristics and a high bandwidth). In the velocity value V2, the integral error is suppressed, and the effects of the gravitational force and the rotation are suppressed. According to the embodiment, by combining the RIG and the Acc, the acceleration of the linear motion and the acceleration due to the gravitational force can be separated, and the velocity is obtained with high accuracy.

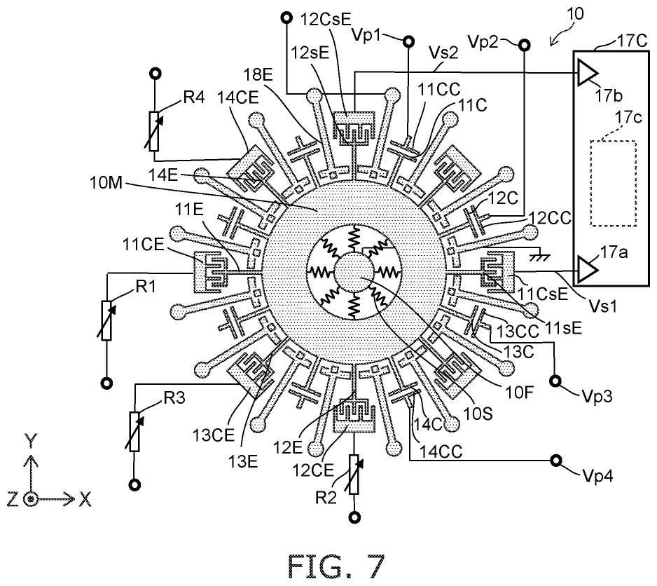

FIG. 7 is a schematic plan view illustrating a portion of the sensor according to the embodiment.

FIG. 7 illustrates the angle gyro sensor 10. The angle gyro sensor 10 includes a first base body 10F, a first movable body 10M, a first supporter 10S, and a first control circuit 17C. The first supporter 10S is fixed to the first base body 10F. The first supporter 10S supports the first movable body 10M to be separated from the first base body 10F so that the first movable body 10M can be vibrated.

For example, the first movable body 10M is displaceable with respect to the first base body 10F in the X-axis, Y-axis, and Z-axis directions.

For example, the first movable body 10M includes a first electrode 11E, a second electrode 12E, a first sensing electrode 11sE, and a second sensing electrode 12sE. In the example, the direction from the first electrode 11E toward the first sensing electrode 11sE are along the X-axis direction. In the example, the direction from the second electrode 12E toward the second sensing electrode 12sE is along the Y-axis direction. The first base body 10F includes a first counter electrode 110E, a second counter electrode 12CE, a first counter sensing electrode 11CsE, and a second counter sensing electrode 12CsE. The first counter electrode 110E, the second counter electrode 12CE, the first counter sensing electrode 11CsE, and the second counter sensing electrode 12CsE respectively face the first electrode 11E, the second electrode 12E, the first sensing electrode 11sE, and the second sensing electrode 12sE. For example, comb electrode pairs are formed of these electrodes and counter electrodes.

For example, an alternating current voltage is applied to the first and second counter electrodes 110E and 12CE. The first movable body 10M is vibrated thereby. When the first movable body 10M rotates in this state, signals (a first sense signal Vs1 and a second sense signal Vs2) that correspond to the rotation are generated in the first and second counter sensing electrodes 11CsE and 12CsE. The first sense signal Vs1 is detected by a circuit 17a provided in the first control circuit 17C. The second sense signal Vs2 is detected by a circuit 17b provided in the first control circuit 17C.

The vibration state of the vibrating first movable body 10M changes when rotated by the application of an external force, etc. For example, it is considered that the change of the vibration state is due to the action of a Coriolis force. For example, the first movable body 10M is vibrated by a spring mechanism (e.g., the supporter 10S). For example, a Coriolis force due to an angular velocity Ω of the rotation acts on the first movable body 10M that is vibrating in a first direction (e.g., the X-axis direction). Thereby, a vibration component of the first movable body 10M is generated along a second direction (e.g., the Y-axis direction). The circuit 17b detects the amplitude of the vibration along the second direction. On the other hand, a Coriolis force due to the angular velocity Ω of the rotation acts on the first movable body 10M that vibrates in the second direction. Thereby, a vibration component of the first movable body 10M is generated along the first direction. The circuit 17b detects the amplitude of the vibration along the first direction. For example, the rotation angle (the first angle value θ1) corresponds to tan⁻¹ (−Ay/Ax), wherein “Ax” is the amplitude of a first component in the first direction, and “Ay” is the amplitude of a second component in the second direction. Thus, the first angle value θ1 can be detected by the angle gyro sensor 10.

In the angle gyro sensor 10, the first control circuit 17C is configured to output, as the first angle value θ1, a signal (e.g., −Ay/Ax) generated by processing the signals (the first sense signal Vs1 and the second sense signal Vs2) corresponding to the vibrations in directions crossing the direction in which the first movable body 10M vibrates.

As shown in FIG. 7, a first resistance R1 may be connected to the first counter electrode 110E. A second resistance R2 may be connected to the second counter electrode 12CE. An alternating current voltage that has a direct current voltage component may be applied to the terminal of the first resistance R1. An alternating current voltage that has a direct current voltage component may be applied to the terminal of the second resistance R2. By adjusting the direct current voltage components, the symmetry of the vibration and the detection can be improved, and detection with higher accuracy is possible. The first resistance R1 and the second resistance R2 may be variable resistance. By controlling the first resistance R1 and the second resistance R2, the symmetry of the vibration and the detection can be improved, and higher accuracy is obtained. For example, these resistances are adjusted to reduce the time constant difference between the first sense signal Vs1 and the second sense signal Vs2. For example, these resistances may be adjusted to reduce the resonant frequency difference between the first sense signal Vs1 and the second sense signal Vs2. For example, the adjustment may be performed by an adjuster 17c provided in the first control circuit 17C, etc.

As shown in FIG. 7, the first movable body 10M may further include a third electrode 13E and a fourth electrode 14E. The first base body 10F may further include a third counter electrode 13CE and a fourth counter electrode 14CE. The third counter electrode 13CE and the fourth counter electrode 14CE respectively face the third electrode 13E and the fourth electrode 14E. For example, comb electrode pairs are formed of these electrodes and counter electrodes. A third resistance R3 may be connected to the third counter electrode 13CE; and a fourth resistance R4 may be connected to the fourth counter electrode 14CE. A direct current voltage for adjusting may be applied to the terminal of the third resistance R3. A direct current voltage for adjusting may be applied to the terminal of the fourth resistance R4.

As shown in FIG. 7, the first movable body 10M may further include first to fourth conductive portions 11C to 14C. The first base body 10F may further include first to fourth counter conductive portions 11CC to 14CC. The first to fourth counter conductive portions 11CC to 14CC respectively face the first to fourth conductive portions 11C to 14C. A parallel-plate electrode pair is formed of one conductive portion and one counter conductive portion. Electrical signals (voltages Vp1 to Vp4) can be input to the first to fourth counter conductive portions 11CC to 14CC. For example, the parallel-plate electrode pairs correspond to variable electric springs. For example, the resonant frequency can be controlled in any direction by the multiple variable electric springs.

As shown in FIG. 7, another electrode 18E may be provided. A voltage may be applied to the other electrode 18E by the first control circuit 17C. Various operations that improve the characteristics may be performed by the other electrode 18E.

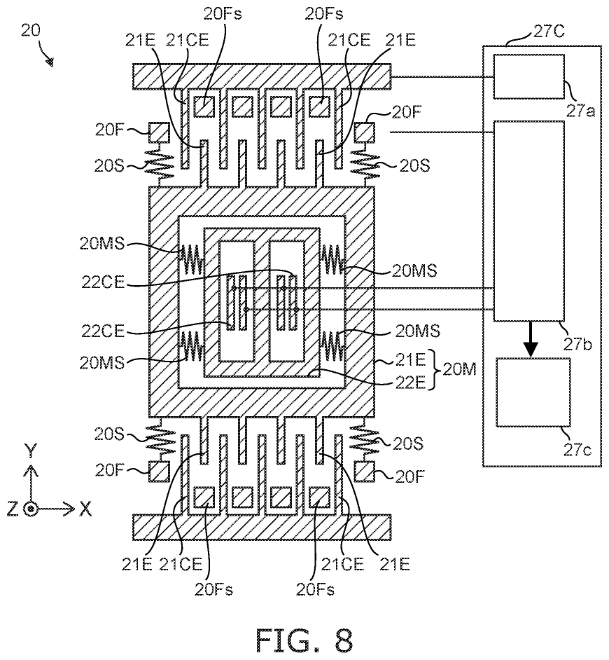

FIG. 8 is a schematic plan view illustrating a portion of the sensor according to the embodiment.

FIG. 8 illustrates the angular velocity gyro sensor 20. The angular velocity gyro sensor 20 includes a second base body 20F, a second movable body 20M, a second supporter 20S, and a second control circuit 27C. The second supporter 20S is fixed to the second base body 20F. The second supporter 20S supports the second movable body 20M to be separated from the second base body 20F so that the second movable body 20M can be vibrated.

The second movable body 20M includes a conductive portion 21E and a conductive portion 22E. In the example, the second supporter 20S supports the conductive portion 21E of the second movable body 20M. The second movable body 20M includes a movable supporter 20MS. The movable supporter 20MS is connected to the conductive portion 21E and the conductive portion 22E. The movable supporter 20MS supports the conductive portion 22E.

The second base body 20F includes a counter conductive portion 210E and a counter conductive portion 22CE. The counter conductive portion 210E faces a protrusion of the conductive portion 21E. A comb electrode pair is formed of the counter conductive portion 210E and the conductive portion 21E. The counter conductive portion 22CE faces the conductive portion 22E.

A drive circuit 27a is provided in the second control circuit 27C. For example, an alternating current voltage is applied to the counter conductive portion 210E by the drive circuit 27a. The second movable body 20M is vibrated thereby. In the example, the vibration is along the Y-axis direction.

The vibration state of the vibrating second movable body 20M changes when an angular velocity occurs due to the application of an external force, etc. For example, it is considered that the change of the vibration state is due to the action of a Coriolis force. For example, a vibration that has a component along the X-axis direction is generated in at least one of the conductive portion 21E or the conductive portion 22E. The magnitude of the vibration having the component along the X-axis direction can be detected as a signal (e.g., the change of the electrical capacitance) generated between the counter conductive portion 22CE and the conductive portion 22E.

In the example, multiple portions are provided in the conductive portion 22E; and multiple counter conductive portions 22CE are provided. For example, the potential difference between one of the multiple portions of the conductive portion 22E and one of the multiple counter conductive portions 22CE and the potential difference between another one of the multiple portions of the conductive portion 22E and another one of the multiple counter conductive portions 22CE are detected by a detector 27b of the second control circuit 27C. The angular velocity (the first angular velocity value Ω1) is derived by the result detected by the detector 27b being processed by an angular velocity calculator 27c of the second control circuit 27C. The derived angular velocity value is output from the second control circuit 27C.

Thus, the second control circuit 27C is configured to output, as the first angular velocity value Ω1, a signal that corresponds to a vibration in a direction crossing the direction in which the second movable body 20M vibrates.

A plurality of the structures shown in FIG. 8 may be provided and may have different axis directions. In the example as shown in FIG. 8, a stopper 20Fs may be provided in the second base body 20F.

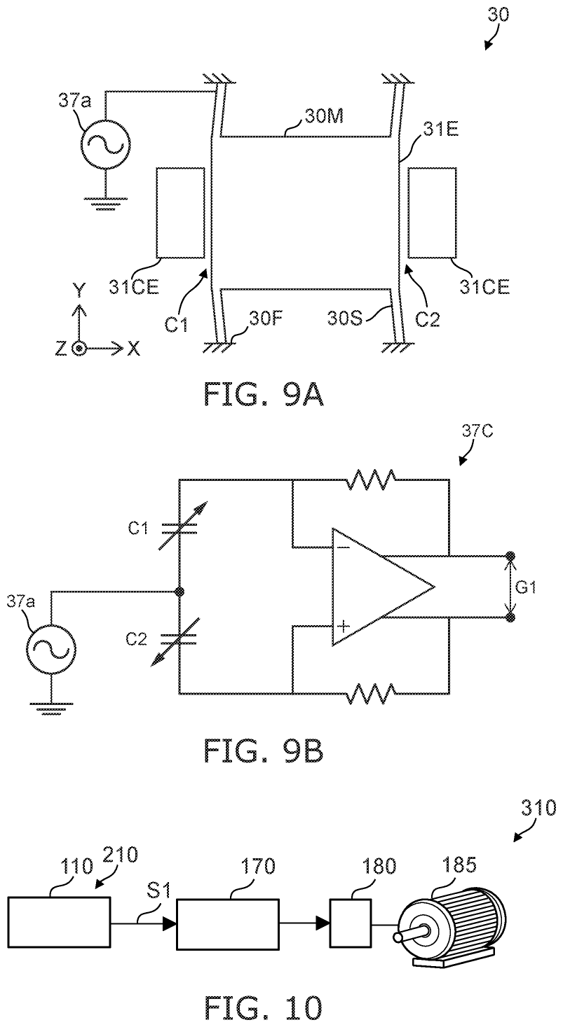

FIGS. 9A and 9B are schematic views illustrating a portion of the sensor according to the embodiment. FIG. 9A is a schematic plan view illustrating the acceleration sensor 30. FIG. 9B is a circuit diagram.

As shown in FIGS. 9A and 9B, the acceleration sensor 30 includes a third base body 30F, a third movable body 30M, a third supporter 30S, and a third control circuit 37C. The third supporter 30S is fixed to the third base body 30F. The third supporter 30S supports the third movable body 30M to be separated from the third base body 30F. The third movable body 30M is displaceable relative to the third base body 30F.

In the example, the third base body 30F includes multiple counter electrodes 30CE. The third movable body 30M is located between the multiple counter electrodes 30CE. The third movable body 30M includes a portion that faces one of the multiple counter electrodes 30CE, and a portion that faces another one of the multiple counter electrodes 30CE. These portions function as electrodes 31E. A first capacitance C1 is formed between one of the multiple counter electrodes 30CE and the portion (the electrode 31E) that faces the one of the multiple counter electrodes 30CE. A second capacitance C2 is formed between another one of the multiple counter electrodes 30CE and the portion (the electrode 31E) that faces the other one of the multiple counter electrodes 30CE. The increase and decrease of the first capacitance C1 and the increase and decrease of the second capacitance C2 have a mutually-reversed relationship.

For example, the third control circuit 37C includes a drive circuit 37a. For example, an alternating current voltage is supplied to the third movable body 30M by the drive circuit 37a. The third movable body 30M is vibrated thereby. In the example, the direction of the vibration is the X-axis direction. The change of the first capacitance C1 and the change of the second capacitance C2 when an acceleration is applied to such a third movable body 30M is different from when the acceleration is not applied.

As shown in FIG. 9B, the voltage of the first capacitance C1 and the voltage of the second capacitance C2 are differentially amplified by the third control circuit 37C. The signal that corresponds to the voltage obtained by the differential amplification is output as the first acceleration value G1. A plurality of the structures shown in FIG. 9A having different axis directions may be provided.

### Third Embodiment

A third embodiment relates to an electronic device.

FIG. 10 is a schematic view illustrating the electronic device according to the third embodiment.

As shown in FIG. 10, the electronic device 310 according to the third embodiment includes a circuit controller 170 and the sensor according to the first or second embodiment. The sensor 110 (or the sensor 210) is used as the sensor in the example of FIG. 10. The circuit controller 170 is configured to control a circuit 180 based on a signal S1 obtained from the sensor. The circuit 180 is, for example, a control circuit of a drive device 185, etc. According to the embodiment, the circuit 180 for controlling the drive device 185 and the like can be controlled with high accuracy based on the high-accuracy detection result.

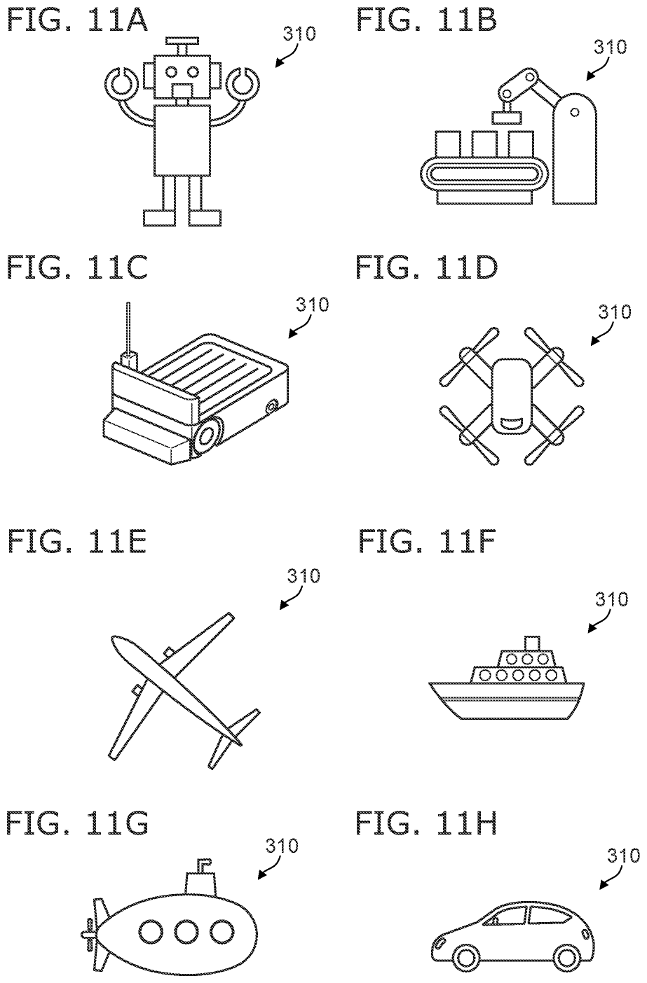

FIGS. 11A to 11H are schematic views illustrating applications of the electronic device.

As shown in FIG. 11A, the electronic device 310 may be at least a portion of a robot. As shown in FIG. 11B, the electronic device 310 may be at least a portion of a machining robot provided in a manufacturing plant, etc. As shown in FIG. 11C, the electronic device 310 may be at least a portion of an automatic guided vehicle inside a plant, etc. As shown in FIG. 11D, the electronic device 310 may be at least a portion of a drone (an unmanned aircraft). As shown in FIG. 11E, the electronic device 310 may be at least a portion of an airplane. As shown in FIG. 11F, the electronic device 310 may be at least a portion of a ship. As shown in FIG. 11G, the electronic device 310 may be at least a portion of a submarine. As shown in FIG. 11H, the electronic device 310 may be at least a portion of an automobile. The electronic device 310 according to the third embodiment may include, for example, at least one of a robot or a moving body.

Embodiments may include the following configurations (e.g., technological proposals).
Configuration 1

A sensor, comprising:

a processor configured to
acquire a first angle value from an angle gyro sensor and acquire a first angular velocity value from an angular velocity gyro sensor, and
perform at least first processing,

the first processing including outputting a second angular velocity value by correcting the first angular velocity value by using a value obtained by filtering a difference between the first angle value and a post-processing angle value,

the post-processing angle value being obtained by processing the first angular velocity value.
Configuration 2

The sensor according to Configuration 1, wherein

the post-processing angle value is obtained by integrating the first angular velocity value.
Configuration 3

The sensor according to Configuration 1 or 2, wherein

the filtering includes Kalman filtering of the difference.
Configuration 4

The sensor according to Configuration 1 or 2, wherein

the filtering includes processing based on a first-principle model.
Configuration 5

The sensor according to any one of Configurations 1 to 4, wherein

the acquiring further includes acquiring a first acceleration value from an acceleration sensor,

the processor is configured to perform at least second processing, and

the second processing includes deriving a second acceleration value by correcting the first acceleration value based on a correction value based on the first angle value and a gravitational force.
Configuration 6

The sensor according to Configuration 5, wherein

the correction value is based on a product of the gravitational force and a sine of the first angle value.
Configuration 7

The sensor according to Configuration 5 or 6, wherein

the second processing includes separating:
an acceleration of a linear motion; and
a gravitational force change based on a rotation.
Configuration 8

The sensor according to any one of Configurations 5 to 7, wherein

the second processing includes outputting a velocity value by integrating the second acceleration value.
Configuration 9

The sensor according to any one of Configurations 5 to 8, further comprising:

the acceleration sensor.
Configuration 10

The sensor according to any one of Configurations 4 to 9, wherein

the first angle value includes:
an X-axis angle value relating to an X-axis;
a Y-axis angle value relating to a Y-axis; and
a Z-axis angle value relating to a Z-axis,

the first acceleration value includes:
an X-axis acceleration value relating to the X-axis;
a Y-axis acceleration value relating to the Y-axis; and
a Z-axis acceleration value relating to the Z-axis, and

the X-axis, the Y-axis, and the Z-axis are orthogonal to each other.
Configuration 11

The sensor according to any one of Configurations 1 to 9, wherein

the first angle value includes:
an X-axis angle value relating to an X-axis;
a Y-axis angle value relating to a Y-axis; and
a Z-axis angle value relating to a Z-axis,

the first angular velocity value includes:
an X-axis angular velocity value relating to the X-axis;
a Y-axis angular velocity value relating to the Y-axis; and
a Z-axis angular velocity value relating to the Z-axis, and

the X-axis, the Y-axis, and the Z-axis are orthogonal to each other.
Configuration 12

The sensor according to any one of Configurations 1 to 11, wherein

the first angle value is obtained by the angle gyro sensor directly measuring an angle of a detection object.
Configuration 13

The sensor according to any one of Configurations 1 to 12, further comprising:

the angle gyro sensor,

the angle gyro sensor including
a first base body,
a first movable body,
a first supporter fixed to the first base body, the first supporter supporting the first movable body to be separated from the first base body so that the first movable body can be vibrated, and
a first control circuit,

the first control circuit being configured to output, as the first angle value, a signal generated by processing a signal corresponding to a vibration in a direction crossing a vibration direction of the first movable body.
Configuration 14

The sensor according to any one of Configurations 1 to 13, further comprising:

the angular velocity gyro sensor,

the angular velocity gyro sensor including
a second base body,
a second movable body,
a supporter fixed to the second base body, the supporter supporting the second movable body to be separated from the second base body so that the second movable body can be vibrated, and
a second control circuit,

the second control circuit being configured to output, as the first angular velocity value, a signal corresponding to a vibration in a direction crossing a vibration direction of the second movable body.
Configuration 15

A sensor, comprising:

a processor configured to
acquire a first angle value from an angle gyro sensor and acquire a first acceleration value from an acceleration sensor, and
perform at least second processing,

the second processing including deriving a second acceleration value by correcting the first acceleration value based on a correction value based on the first angle value and a gravitational force.
Configuration 16

The sensor according to Configuration 15, wherein

the correction value is based on a product of the gravitational force and a sine of the first angle value.
Configuration 17

The sensor according to Configuration 15 or 16, wherein

the second processing includes separating:
an acceleration of a linear motion; and
a gravitational force change based on a rotation.
Configuration 18

The sensor according to any one of Configurations 15 to 17, wherein

the second processing includes outputting a velocity value by integrating the second acceleration value.
Configuration 19

An electronic device, comprising:

the sensor according to any one of Configurations 1 to 18; and

a circuit controller configured to control a circuit based on a signal obtained from the sensor.
Configuration 20

The electronic device according to Configuration 19, wherein

the electronic device includes at least one of a robot or a moving body.

According to embodiments, a sensor and an electronic device can be provided in which the accuracy can be increased.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as angle gyro sensors, angular velocity gyro sensors, acceleration sensors, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a processor configured to
acquire a first angle value from an angle gyro sensor and acquire a first angular velocity value from an angular velocity gyro sensor, and
perform at least first processing,
the first processing including outputting a second angular velocity value by correcting the first angular velocity value by using a value obtained by filtering a difference between the first angle value and a post-processing angle value,
the post-processing angle value being obtained by processing the first angular velocity value.

2. The sensor according to claim 1, wherein
the post-processing angle value is obtained by integrating the first angular velocity value.

3. The sensor according to claim 1, wherein
the filtering includes Kalman filtering of the difference.

4. The sensor according to claim 1, wherein
the filtering includes processing based on a first-principle model.

5. The sensor according to claim 1, wherein
the acquiring further includes acquiring a first acceleration value from an acceleration sensor,
the processor is configured to perform at least second processing, and
the second processing includes deriving a second acceleration value by correcting the first acceleration value based on a correction value based on the first angle value and a gravitational force.

6. The sensor according to claim 5, wherein
the correction value is based on a product of the gravitational force and a sine of the first angle value.

7. The sensor according to claim 5, wherein
the second processing includes separating:
an acceleration of a linear motion; and
a gravitational force change based on a rotation.

8. The sensor according to claim 5, wherein
the second processing includes outputting a velocity value by integrating the second acceleration value.

9. The sensor according to claim 5, further comprising:
the acceleration sensor.

10. The sensor according to claim 4, wherein
the first angle value includes:
an X-axis angle value relating to an X-axis;
a Y-axis angle value relating to a Y-axis; and
a Z-axis angle value relating to a Z-axis,
the first acceleration value includes:
an X-axis acceleration value relating to the X-axis;
a Y-axis acceleration value relating to the Y-axis; and
a Z-axis acceleration value relating to the Z-axis, and
the X-axis, the Y-axis, and the Z-axis are orthogonal to each other.

11. The sensor according to claim 1, wherein
the first angle value includes:
an X-axis angle value relating to an X-axis;
a Y-axis angle value relating to a Y-axis; and
a Z-axis angle value relating to a Z-axis,
the first angular velocity value includes:
an X-axis angular velocity value relating to the X-axis;
a Y-axis angular velocity value relating to the Y-axis; and
a Z-axis angular velocity value relating to the Z-axis, and
the X-axis, the Y-axis, and the Z-axis are orthogonal to each other.

12. The sensor according to claim 1, wherein
the first angle value is obtained by the angle gyro sensor directly measuring an angle of a detection object.

13. The sensor according to claim 1, further comprising:
the angle gyro sensor,
the angle gyro sensor including
a first base body,
a first movable body,
a first supporter fixed to the first base body, the first supporter supporting the first movable body to be separated from the first base body so that the first movable body can be vibrated, and
a first control circuit,
the first control circuit being configured to output, as the first angle value, a signal generated by processing a signal corresponding to a vibration in a direction crossing a vibration direction of the first movable body.

14. The sensor according to claim 1, further comprising:
the angular velocity gyro sensor,
the angular velocity gyro sensor including
a second base body,
a second movable body,
a supporter fixed to the second base body, the supporter supporting the second movable body to be separated from the second base body so that the second movable body can be vibrated, and
a second control circuit,
the second control circuit being configured to output, as the first angular velocity value, a signal corresponding to a vibration in a direction crossing a vibration direction of the second movable body.

15. A sensor, comprising:
a processor configured to
acquire a first angle value from an angle gyro sensor and acquire a first acceleration value from an acceleration sensor, and
second processing,
the second processing including deriving a second acceleration value by correcting the first acceleration value based on a correction value based on the first angle value and a gravitational force.

16. The sensor according to claim 15, wherein
the correction value is based on a product of the gravitational force and a sine of the first angle value.

17. The sensor according to claim 15, wherein
the second processing includes separating:
an acceleration of a linear motion; and
a gravitational force change based on a rotation.

18. The sensor according to claim 15, wherein
the second processing includes outputting a velocity value by integrating the second acceleration value.

19. An electronic device, comprising:
the sensor according to claim 1; and
a circuit controller configured to control a circuit based on a signal obtained from the sensor.

20. The device according to claim 19, wherein
the device includes at least one of a robot or a moving body.
